(19) United States
(12) Patent Application Publication
(10) Pub. No.: US 2002/0056694 A1
(43) Pub. Date: May 16, 2002

(54) Support for a track-bound crane vehicle, especially for a two-way vehicle

(75) Inventors: Ralf Rode, Schwalmtal (DE); Klaus Sprave, Kaarst (DE)

Correspondence Address: COHEN, PONTANI, LIEBERMAN & PAVANE, Suite 1210, 551 Fifth Avenue, New York, NY, 10176, US

(73) Assignee: Atecs Mannesmann AG

(21) Appl. No.: 09/849,692

(22) Filed: May 4, 2001

(30) Foreign Application Priority Data
May 5, 2000 (DE) 100 23 077.6

(51) Int. Cl. B66C 7/06

(52) U.S. Cl. 212/312

(57) ABSTRACT

The invention pertains to a support for a track-bound crane vehicle, especially for a two-way crane vehicle for combined use on both roads and rails, which can be lifted from the tracks and set back down onto them by means of vertically-acting support cylinders, where, to distribute the support forces, each support cylinder is supported on a support plate. Each support plate horizontal bottom plate which can rest on the ground and a slide plate, which can slide over the top of the bottom plate. The upper surface of this slide plate is provided with a receptacle for a vertically-acting support cylinder.

### BACKGROUND OF THE INVENTION

1. Field of the Invention

The invention pertains to a support for a track-bound crane vehicle, especially for a two-way vehicle for operation on both roads and rails, which can be lifted by vertically-acting support cylinders from the rails and set back down onto them again, where, to distribute the support forces, each support cylinder is supported on a support plate.

2. Description of the Related Art

During use, track-bound cranes or two-way cranes are lifted from the rails by means of their supports to take the load off the tracks. While the crane is doing its work, the supported crane can become shifted in such a way that it is difficult or impossible to get it back on the tracks. This problem occurs especially during crane work in banked rail curves. Until now, crane vehicles which had shifted toward the side had to be brought back into the center of the tracks by means of chain blocks or other means; this work is very time consuming and hazardous.

A similar problem occurs when two-way vehicles are used for combined use on the road and on tracks. After starting off on the road, two-way crane vehicles can be put on the tracks relatively quickly. The unit can then also be used both as a track crane and as a road-worthy telescope crane. Two-way crane vehicles are suitable both for the rescue, for example, of track vehicles and street vehicles and also for the laying of track. When they start off on the road, they have the driving behavior of a truck, and when traveling on tracks, they have the behavior of a streetcar. Putting such a vehicle on the tracks is done by maneuvering the vehicle so that it is positioned precisely over the center of the tracks, which often presents considerable difficulties for various reasons.

### SUMMARY OF THE INVENTION

The object of the present invention is to find a solution by means of which railway cranes or two-way cranes can be pushed quickly and reliably and also safely into the center of the tracks.

In accordance with the invention, each support plate is divided into two parts, a horizontal bottom plate on the bottom, which can rest on the ground, and a slide plate on top, which can slide over the bottom plate. The top of this slide plate is provided with a receptacle for a vertically acting support cylinder of the crane vehicle.

The horizontal support plates can be used for support during crane work and also for pushing the crane vehicle back into the center of the tracks. For this purpose, the two-part support plates are made so that the crane, which is standing by its support cylinders on the slide plates, can be slid over the lower bottom plates and thus pushed to the center of the tracks in a matter of minutes. The coefficient of friction between the slide plate and the bottom plate, however, must be smaller than the coefficient of friction between the bottom plate and the ground, and the sliding process must take place at two support plates at the same time.

To slide the slide plate over the bottom plate, at least one abutment for a drive apparatus acting between the bottom plate and the slide plate is affixed to the bottom plate. The abutment can be screwed to the bottom plate or welded to it, and serves as a thrust block for the drive apparatus.

The drive apparatus is preferably designed as a spindle, which is connected at one end to the abutment on the bottom plate by a spindle nut, in which it can turn, and at the other end to a receptacle for the vertically-acting support cylinder. The spindle drive represents simple and reliably functioning kinematics, by means of which even very powerful sliding forces can be exerted in a controlled manner. The spindle is also self-locking.

To compensate for tilts of the supports on uneven ground, the spindle nut for the spindle is preferably mounted for universal movement with respect to the abutment on the bottom plate. As a result, the spindle can adjust itself freely without jamming.

In an alternative design of the invention, the drive apparatus is designed as a cylinder operated by a pressure medium. This cylinder is hinged at one end to the abutment of the bottom plate and at the other end to the receptacle for the vertically-acting support cylinder or, alternatively, directly to the slide plate.

Each slide plate is preferably suspended from the support cylinder assigned to it, and each bottom plate is suspended from the slide plate, so that, after the support plate has been lifted, it can remain on the crane during travel over the tracks or over the road. The bottom plate is shaped on the bottom to increase its coefficient of friction.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a longitudinal cross section through the support according to the invention in the area of the support cylinder;

FIG. 2 shows a cross section through a support cylinder according to FIG. 1 in a view looking down from above;

FIG. 3 shows a side view of the support with the abutment for the drive apparatus;

FIG. 4 shows a side view of the support with a ratchet lever for actuating the spindle; and

FIG. 5 is a view similar to FIG. 2, wherein the slide plate is driven by a hydraulic cylinder.

### DETAILED DESCRIPTION OF THE PRESENTLY PREFERRED EMBODIMENTS

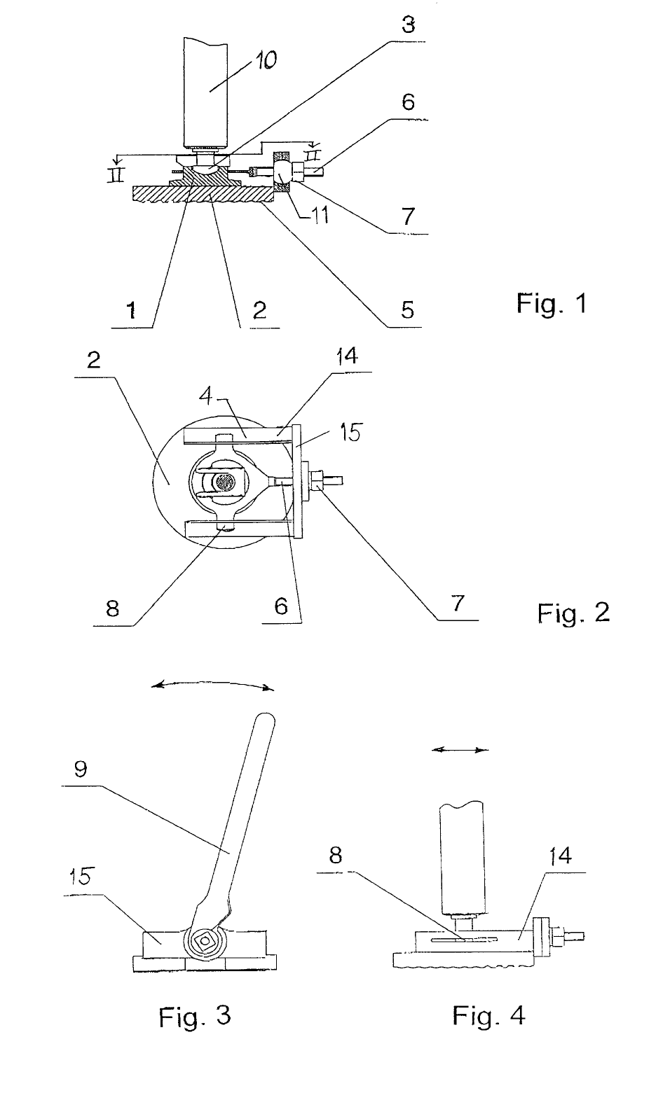

FIG. 1 shows a longitudinal cross section through the support in the area of the support cylinder. The support plate includes two plates, the upper slide plate 1 and the bottom plate 2, as well as a device by means of which the slide plate 1 can be pushed horizontally over the bottom plate 2. On the slide plate 1 is a receptacle 3 for the support cylinder, whereas the abutment 4 for the drive apparatus 6, 7 is mounted on the bottom plate 2. The shape of the plates (round, rectangular, etc.) is irrelevant; the bottom plate 2 is provided with a shaped traction surface 5 on the bottom to increase its coefficient of friction.

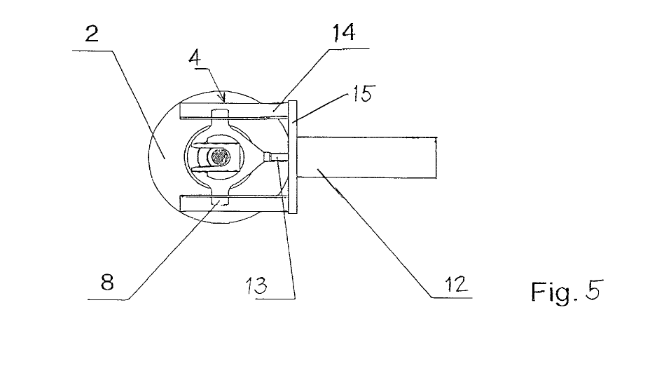

The drive apparatus is shown in FIG. 2 in cross section through a support cylinder. It includes spindle 6 connected to the slide plate 1 and a spindle nut 7. The abutment 4 includes a pair of sidewalls 14 and an end wall 15. The spindle nut 7, which is supported by a ball joint 11 in the end wall 15, engages threads on the spindle and supports it. By means of the ratchet lever 9 (FIG. 3), the spindle nut 7 is turned, as a result of which the spindle moves axially in the nut and the slide plate 1 is shifted with respect to the bottom plate 2. It is also possible to install a hydraulic cylinder 12 having a piston rod 13 in place of the spindle 6 and its spindle nut 7 (FIG. 5). Such a cylinder is preferably a two-way cylinder.

The sliding device is self-locking, regardless of its design. The slide plate 1 is prevented from being lifted off the bottom plate 2 by a slip ring 8 (FIG. 4), guided in slots in the sidewalls 14.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. Apparatus for supporting a track-bound crane vehicle which can be lifted from a set of tracks and set back down of the tracks by means of vertically-acting support cylinders, said apparatus comprising a support plate for each of said support cylinders, each said support plate comprising
a bottom plate which can rest on the ground, said bottom plate having a top surface, and
a slide plate mounted on the bottom plate, which slide plate can slide on the top surface of the bottom plate, said slide plate having a receptacle which supports one of said vertically acting cylinders.

2. Apparatus as in claim 1 further comprising
an abutment fixed on said bottom plate, and
a drive apparatus acting between said abutment and said slide plate to cause said slide plate to slide on said top surface of said bottom plate.

3. Apparatus as in claim 2 wherein said drive apparatus comprises a spindle fixed to said slide plate and a spindle nut rotatably mounted to said abutment, said spindle passing through said nut and being axially movable with respect to said abutment by rotating said spindle nut.

4. Apparatus as in claim 3 wherein said spindle nut is mounted for universal movement with respect to said abutment.

5. Apparatus as in claim 2 wherein said drive apparatus comprises a pressure medium cylinder and a piston rod driven by said cylinder.

6. Apparatus as in claim 5 wherein said cylinder is mounted to said abutment and said piston rod is fixed to said slide plate.

7. Apparatus as in claim 1 wherein said bottom plate has a bottom surface which is configured as a traction surface so that there is a higher coefficient of friction between the bottom surface and the ground than between the top surface and the slide plate.
